(19) United States
(12) Patent Application Publication
(10) Pub. No.: US 2022/0134656 A1
(43) Pub. Date: May 5, 2022

(54) Movement of a Build Unit in a 3D Printer

(71) Applicant: Hewlett-Packard Development Company, L.P., Spring, TX (US)

(72) Inventors: Eduard Galdeano Castillo, Sant Cugat del Valles (ES); Guillermo Moliner Clemente, Sant Cugat del Valles (ES); Alejandro Torres Pinero, Sant Cugat del Valles (ES)

(73) Assignee: Hewlett-Packard Development Company, L.P., Spring, TX (US)

(21) Appl. No.: 17/416,369

(22) PCT Filed: Jul. 23, 2019
(86) PCT No.: PCT/US2019/043073

§ 371 Date: Jun. 18, 2021

(51) Int. Cl. B29C 64/232; B33Y 40/00; B33Y 30/00; B29C 64/245; B33Y 10/00

(52) U.S. Cl. CPC B29C 64/232; B33Y 40/00; B33Y 10/00; B29C 64/245; B33Y 30/00

(57) ABSTRACT

A 3D printer comprises a printing machine to accommodate a build unit in a print position and a conveyor to move the build unit into the print position and out of the print position. The conveyor is to move the build unit vertically downward into the print position and to move the build unit vertically downward out of the print position. The 3D printer is to move a build platform of the built unit vertically downward relative to the a frame of the build unit as successive layers of build material are formed on the build platform and are selectively processed while the build unit is in the print position.

### BACKGROUND

3D printers permit three-dimensional objects to be generated. 3D printing may take place on a build platform within a 3D printer. The build platform may be part of a build unit which comprises the build platform and vertical walls extending around a build space or build volume in which 3D printing takes place. The vertical walls may be part of a frame of the build unit. The build platform is movable relative to the frame of the build unit and is lowered relative to the frame while 3D printing takes place. A print job may be printed by shaping an object layer by layer in a build material, such as powder or granulate. A layer of build material may be deposited and selected portions thereof may be solidified. This process may be repeated layer by layer to build solid objects within the build material. Upon finishing the print job, a printed job or cake is obtained, which includes a 3D object or 3D objects and build material which was not solidified. The remaining build material has to be removed later on to obtain the 3D object or the 3D objects.

### BRIEF DESCRIPTION OF THE DRAWINGS

Examples will now be described, by way of non-limited examples, with reference to the accompanying drawings, in which:

FIG. 1 is a schematic view of an example of a 3D printer according to the present disclosure;

FIG. 2 is a schematic view of another example of a 3D printer according to the present disclosure;

FIGS. 3a and 3b show a perspective view and a partially cut away perspective view of an example of a build unit;

FIGS. 4a to 4b show schematic views of an example of a 3D printer to handle several build units one after the other;

FIGS. 5a to 5c show schematic perspective views showing movement of an example of a build unit using a conveyor;

FIG. 6 shows a schematic perspective view of details of an example of a 3D printer comprising first and second sensors;

FIG. 7 shows a flow chart or an example of a method of 3D printing; and

FIG. 8 is a block diagram of a controller according to an example.

### DETAILED DESCRIPTION

In the following detailed description, reference is made to the accompanying drawings. The examples in the description and drawings are to be considered illustrative and are not intended as limiting to the specific example or element described. Multiple examples may be derived from the following description and drawings through modification, combination of variation of certain elements.

Currently, upon printing a print job, the build unit with the printed parts inside may have to cool down for a long period of time or may be taken to a processing station to free up the build unit. In the processing station, the cake may be transferred to another container, in which the cake may cool down before uncaking takes place, i.e. before the 3D object or objects are separated from the non-solidified build material. The other container may be placed on top of the build unit and, thereupon, the cake, such as a hot cake, may be transferred from the build unit to the other container by pushing the build platform upwards. When the cake is transferred to the other container, a rigid sheet, or guillotine, may be used to separate the cake from the build platform of the build unit, wherein the guillotine may act as a base for the cake. Using the guillotine brings about the risk that parts in the cake are moved/shaked while the parts are still hot. In addition, using the guillotine brings about the risk that the position of the parts is shifted and that parts get in the way of the guillotine, which may result in damaged or destroyed parts.

Examples of the present disclosure provide a system helpful in automating print processes in 3D printers, which may eliminate human interaction to insert/remove a build unit from the 3D printer. According to examples of the present disclosure a printed job may remain within the build unit in which it was printed during cool down of the print job and, therefore, the risk of part quality issues may be reduced.

Examples of the present disclosure provide a 3D printer comprising: a printing machine to accommodate a build unit in a print position and a conveyor to move the build unit into the print position and out of the print position. The conveyor is to move the build unit vertically downward into the print position and to move the build unit vertically downward out of the print position. The build platform of the built unit is moved vertically downward relative to the a frame of the build unit as successive layers of build material are formed on the build platform and are selectively processed while the build unit is in the print position. In examples, the build unit is moved vertically downward into the print position before printing starts with the build unit in the print position and is moved vertically downward out of the print position after printing is finished.

Selectively processing may include selectively solidifying while the build unit is in the print position. Selectively processing may include applying a thermally curable binder agent. When using a thermally curable binder agent, the binder agent may be cured in a separate curing station upon completing the print job.

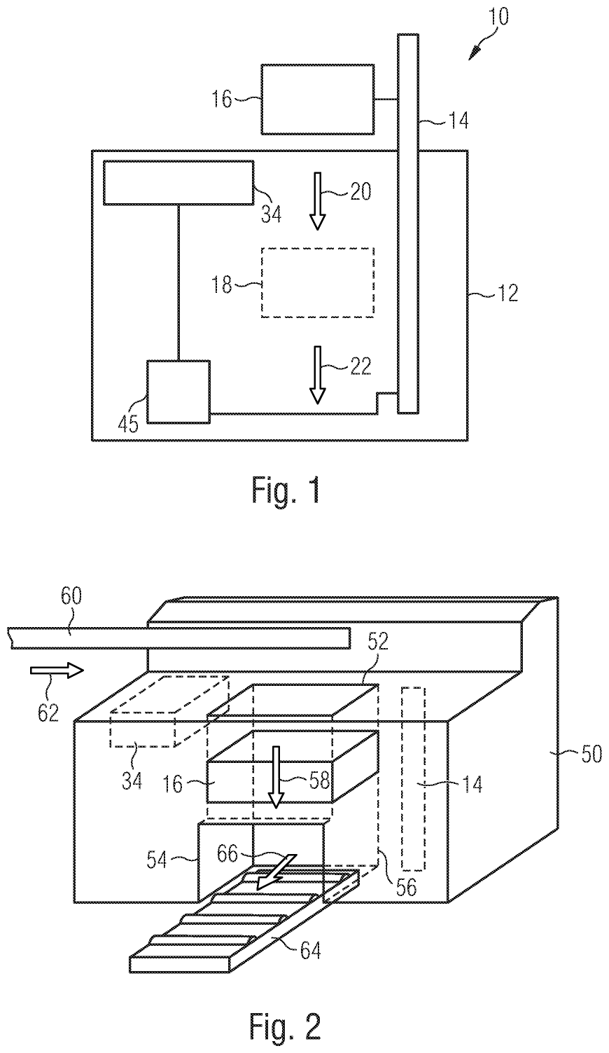

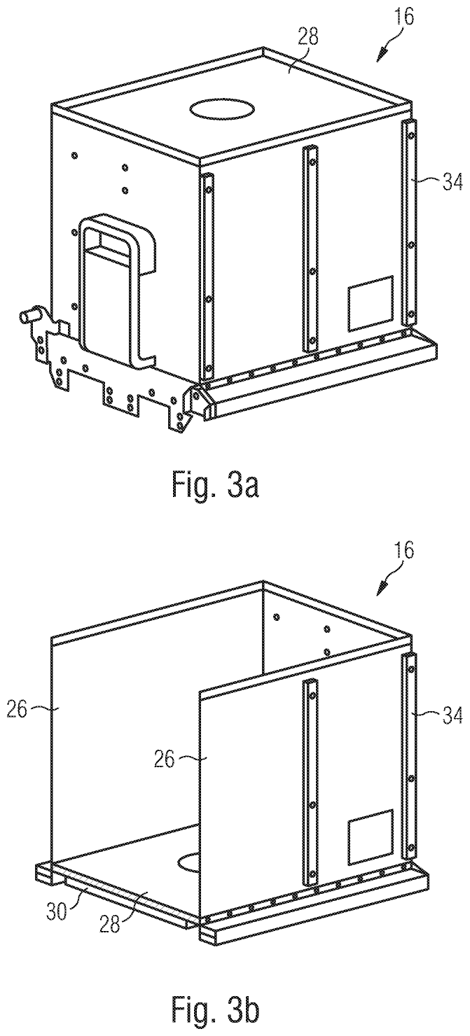

FIG. 1 shows a schematic view of a 3D printer 10 comprising a printing machine 12 and a conveyor 14. The printing machine 12 is to accommodate a build unit 16 in a print position 18. Conveyor 14 is to move the build unit 16 in a first direction, such as vertically downwards, into the print position 18, arrow 20, and out of the print position 18, arrow 22. The build unit 16 may comprise a frame and a build platform movable relative to the frame. The frame may comprise vertical walls surrounding a build volume in which 3D objects may be printed. The vertical walls may represent a wall structure circumferentially surrounding the build platform. An example of a build unit 16 is shown in FIGS. 3a and 3b. The build unit 16 comprises vertical walls 26 extending in a vertical direction relative to a build platform 28. In FIG. 3a, build platform 28 is shown in an upper pre-print position and in FIG. 3b, build platform 28 is shown in a lower post-print position. Build platform 28 is movable within vertical walls 26. Vertical walls 26 extend vertically with respect to the plane in which build platform 28 is arranged, wherein this plane may be parallel to a horizontal plane. Print unit 16 may further include a bottom plate 30 and guide members 34 extending in the vertical direction. In FIG. 3b, the left wall portion of build unit 16 is removed to make visible the position of build platform 28. The parts of the build unit 16 except for movable build platform 28 represent the frame of the build unit 16.

Printing machine 12 is to print 3D objects on build platform 28 while build platform 28 moves relative to the frame of the build unit. To this end, printing machine 12 includes print components 34 to apply material onto build platform 28 to generate 3D objects thereon. It is to be noted that FIG. 1 schematically shows print components 34 which may, for example, be movable horizontally relative to print position 18 so that printing on build platform 28 is possible when build unit 16 is in print position 18. In examples, print components 34 may include a build material dispenser to deposit layers of build material, and a printhead or printheads to selectively apply drops of a printing agent, such as an energy absorbing fusing agent, a chemical binder agent, or the like, to selected portions of the layer of build material. For example, a layer of build material is deposited and selected portions thereof are fused. In examples, this process is repeated layer by layer to build a solid object within the build material. Fusing may be achieved, for example, by selectively depositing drops of a fusing agent to selected portions of the layer of build material. In some examples, a further subsequent process may be to supply energy to the build material on which an agent has been deposited to solidify the build material in accordance with where the agent was deposited. In other examples energy may be applied to cure binder agent. Repeating these processes enables three-dimensional objects to be generated layer-by-layer, through selective solidification of portions of successive layers of build material.

Printing machine 12 further includes a controller 36 communicatively coupled with conveyor 14 and print components 34. Controller 38 is to control print components 34 and conveyor 14 to perform methods and to obtain functionalities as described herein.

In examples, the build unit, which may also be referred to as construction box, is introduced vertically downward into the printer unit. During a 3D printing operation the build platform of the build unit is moved vertically downward as successive layers of build material are formed thereon and are selectively solidified. At the end of the 3D print job, the build unit is ejected vertically downward from the printer unit.

Conveyor 14 is to move build unit 16 vertically downward, arrow 20, into print position 18 while build platform 28 is in the pre-print position relative to the frame of build unit 16. Upon reaching print position 18, the frame of the build unit 16 may be latched in print position 18 and build platform 28 is moved vertically downward relative to the frame of build unit 16 during printing. Movement of build platform 28 relative to the frame of build unit 16 may be achieved using conveyor 14. Thus, in examples, conveyor 14 is to move build platform 28 relative to the frame of build unit 16 in the vertical direction while build unit 16 is latched in the print position 18. After printing, build platform 28 is in the post-print position shown in FIG. 3b. After printing, build unit 16 is moved out of print position 18 vertically downward, arrow 22, by conveyor 14. As used herein unless otherwise stated, the term vertically refers to vertically with respect to the earth's gravitational force.

In examples, moving the build unit vertically downward permits the system to use the same motor/conveyor to lower the build unit into the print position, to remove the build unit from the print position, and to move the build platform down while the build unit is in the print position.

FIG. 2 shows a schematic view of a 3D printer 50 comprising a conveyor 14 and print components 34. While normally hidden behind walls of 3D printer 50, conveyor 14 and print components 34 are shown in broken lines and build unit 16 is shown in FIG. 2 in the print position for illustrative purposes. The 3D printer 50 comprises an upper opening 52 through which print unit 16 may enter 3D printer 50, and a lower opening 54 through which print unit 16 may leave 3D printer 50. A pathway 56 through which build unit 16 may move is provided. Conveyor 14 is to move build unit 16 vertically along a path way 56 as indicated by an arrow 58 in FIG. 2. Pathway is also shown in broken lines in FIG. 2 for illustrative purposes. A first horizontal conveyor 60 may be provided to move build unit 16 in a horizontal direction 52 into a position above upper opening 52. A second horizontal conveyor 64 may be provided to remove build unit 16 in a horizontal direction through lower opening 54. Conveyor 14 may take over build unit 16 from first horizontal conveyor 60 upon positioning build unit 16 above upper opening 52. Second horizontal conveyor 64 may take over build unit 16 from conveyor 14 upon positioning build unit 16 adjacent lower opening 54.

In examples, the horizontal and vertical conveyors described herein may comprise conveyor lines. In examples, the vertical conveyor may comprise a vertical conveyor line or may comprise an elevator structure. In examples, vertical guide members, such as in the form of guide columns, may be provided, along which the build unit is moved using the vertical conveyor. The build unit may always be coupled to the column guide no matter if it's moving down or whether it's resting for printing. Conveyor may be to selectively engage with and disengage from the build platform and/or the frame of the build unit so as to move the build unit and/or the build platform as described herein.

In examples of the present disclosure, the build unit is moved through the 3D printer in the same direction in which the build platform of the build unit is moved relative to the frame of the build unit. Thus, in examples of the present disclosure, the same conveyor moving the build unit through the 3D printer may be used to move the build platform relative to the frame.

In examples of the present disclosure the printed job is extracted after it is completed without being transferred to another container. The printed job, i.e. the cake, may remain inside the container in which it was formed. Thus, moving the cake around and shaking it may be avoided. Leakage of build material, such as powder, may be avoided since moving around and vibrating parts inside a printed shop that is still hot may be avoided. A guillotine does not have to be used to separate the cake from the build platform. Thus, recently printed jobs are not exposed to the atmosphere and, therefore, modification of the cooling profile may be avoided. Not solidified build material, such as powder, inside the cake is not moved around during the transfer of the cake from the build unit to another container. Accordingly, quality issues may be reduced. In examples, the build unit may be inserted/removed from the 3D printer automatically. In examples, additional conveyors to provide the build unit to the conveyor which moves the build unit into and out of the print position may be provided. Thus, the process may be further automated. In examples, the cake is hot after printing and may cool down in the container in which it was printed. In examples, the cake may not be hot after printing, such as if using a binder agent. Thus, the cake may be a hot cake in case of a thermal fusing system or in case of a heat curable binder agent or may be a cold cake in case of UV curable binder agents.

In examples of the present disclosure, print jobs are printed directly in the container in which the cake is transported from the printing machine. In case of a hot cake, cooling down of the hot cake takes place after printing. Thus, the container where the parts are printed is the same as the container where they stay for cool down. Thus, the printed job may be stored for cooldown without shaking it. Since printing takes place in the container in which cooling down takes place, an additional build unit does not have to be provided. In examples in which no substantial heat is generated during printing, the present disclosure still provides an effective manner for continuous printing.

In examples, a plurality of build units may be moved into and out of the print position of the 3D printer one after the other. In examples, the build platform of a first build unit may be moved relative to the frame of the first build unit when the first build unit is in the print position and concurrently a second build unit may be moved in the vertical downward direction towards the print position. In examples, a third build platform may be moved away from the print position in a vertical downward direction while the first build unit is in the print position and/or while the second build unit is moved towards the print position. Accordingly, examples permit a plurality of build units to be handled in a time-saving manner and, therefore, permit the generation of 3D objects in a time saving manner. In examples, this may be achieved using the same conveyor.

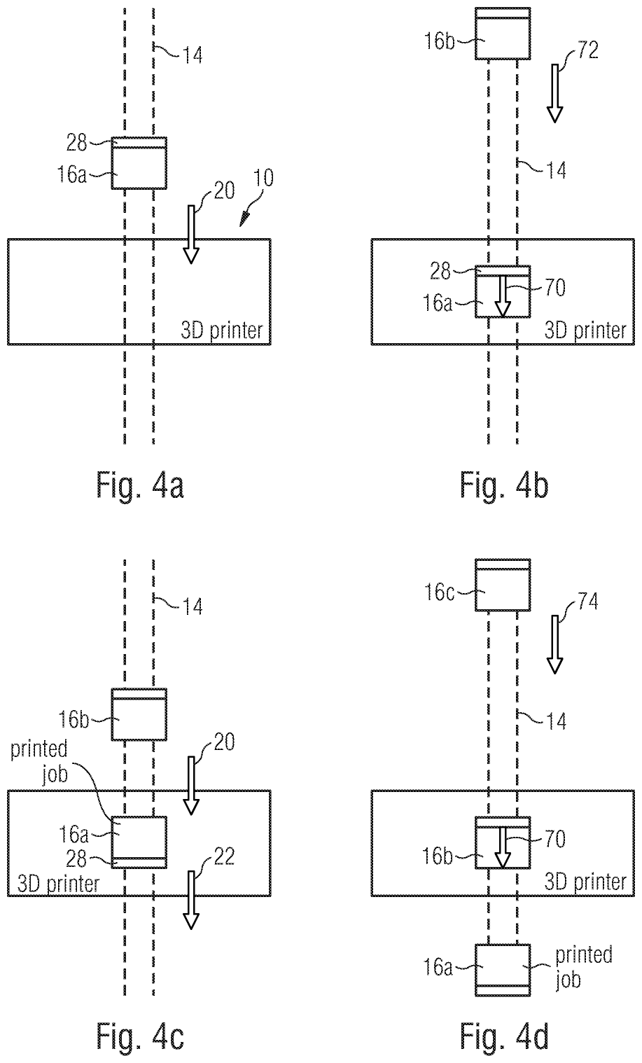

FIG. 4a shows a schematic view of a 3D printer 10 comprising a conveyor 14, wherein a first build unit 16a is lowered, i.e., moved vertically downward, into a print position. Build platform 28 of first print unit 16a is in the pre-print position relative to the frame of first print unit 16a. FIG. 4b shows first print unit 16a in the print position. Printing in the first print unit 16a takes place while first print unit 16a is in the print position and build platform 28 is moved vertically downward relative to the frame of first build unit 16a during printing, as indicated by an arrow 70. This may be achieved using conveyor 14. At the same time, conveyor 14 moves a second print unit 16b vertically downward toward the print position as indicated by an arrow 72. FIG. 4c shows first print unit 16a after finishing the print job, wherein the printed job is arranged within first print unit 16a. At this time, build platform 28 is in the post-print position relative to the frame of first print unit 16a. Second build unit 16b has been moved closer to the print position by conveyor 14. After the print job is done, first build unit 16a along with the printed job is moved out of the print position, arrow 22, while second build unit 16b is moved into the print position, arrow 20. FIG. 4d shows first build unit 16a after moving it out of the print position and second build unit 16b in the print position. While second build unit 16b is in the print position, another build unit 16c may be moved towards the print position using conveyor 14, as indicated by an arrow 74. In this manner, a plurality of print units may be moved into and out of the print position one after the other.

In examples, the conveyor is to be engaged with the frame of the build unit to move the build unit into and out of the print position vertical downward and is to be engaged with the build platform to move the build platform relative to the frame vertically downward during printing while the build unit is in the print position.

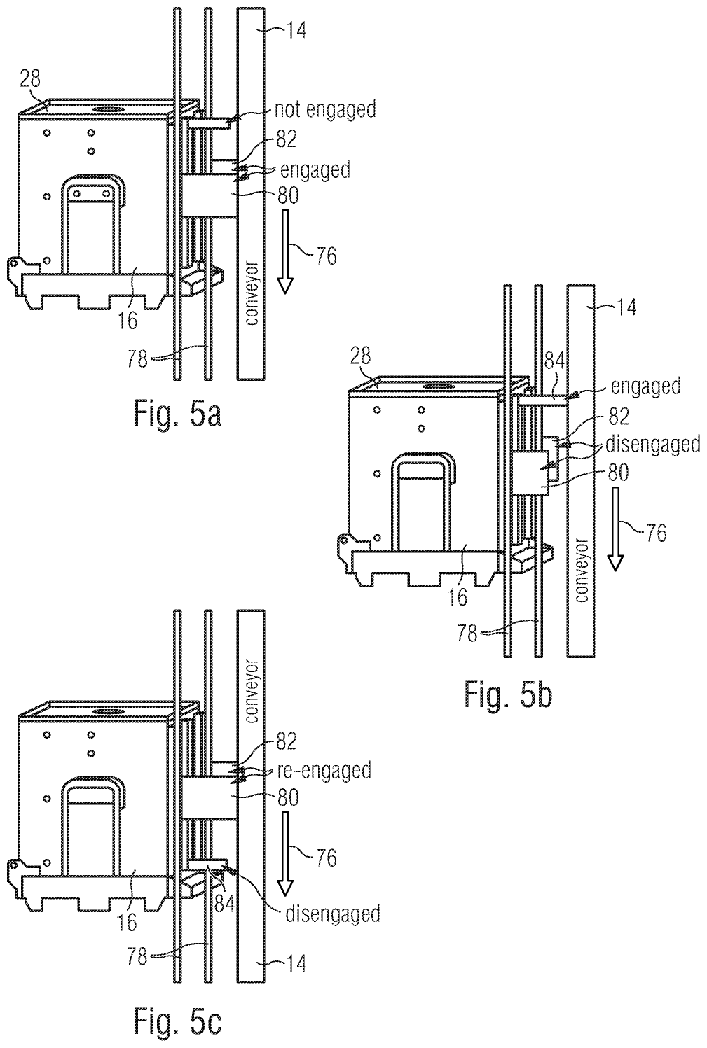

Reference is made to FIGS. 5a to 5c showing conveyor 14, such as a conveyor line, moving vertically downward as indicated by an arrow 76. Column guides 78, along which build unit 16 is moved using conveyor 14 may be provided. Column guides 78 may cooperate with guide members 34 provided on a side face or several side faces of build unit 16. As schematically shown in FIG. 5a, the frame of the build unit 16 is engaged with conveyor 14. To this end, one arm or a plurality of arms 80, 82 fixed to the frame of build unit 16 and extending therefrom may be coupled to conveyor 14. Thus, build unit 16 moves along with conveyor 14. Upon reaching the print position, engagement between the frame of build unit 16 and conveyor 14 is released, such as by retracting arms 80, 82. Thus, the frame of build unit 16 is disengaged from conveyor 14. At this time, build platform 28 is engaged with conveyor 14 such as by one arm 84 or a plurality of arms 84 attached to build platform 28 and extending therefrom. Thus, build platform 28 moves along with conveyor 14. To permit movement of build platform 28 along with conveyor 14, an oblong slot or oblong slots may be provided in the sidewall of build unit 16 facing conveyor 14. Upon finishing printing, arm 84 may be retracted to release the engagement between build unit 16 and conveyor 14. Thus, build platform 28 is disengaged from conveyor 14. The frame of build unit 16 is reengaged with conveyor 14 so that it moves with conveyor 14.

Thus, examples of the present disclosure provide two engagement mechanisms, a first one for effecting engagement and disengagement between the build unit and the conveyor and a second one for effecting engagement and disengagement between the build platform and the conveyor. The conveyor may be continuously moving down. In examples, the conveyor may be moving down in a stepped manner, at least during periods in which printing in a build unit takes place. When the build unit arrives at the print position it is disengaged from the conveyor and the build platform is engaged. After printing is finished, the build platform is disengaged from the conveyor and the build unit is re-engaged.

In examples, the first engagement mechanism is to effect engagement between the frame of the build unit and the conveyor to move the build unit into and out of the print position and to effect disengagement of the frame of the build unit from the conveyor during printing while the build unit is in the print position, and the second engagement mechanism is to effect engagement between the build platform and the conveyor during printing while the build unit is in the print position and to effect disengagement of the build platform from the conveyor when the build unit is moved into and out of the print position.

In examples, the first engagement mechanism comprises a first feature on the build unit and a second feature on the conveyor, which may be brought into and out of contact with each other to effect engagement and disengagement. In examples, the second engagement mechanism comprises a first feature on the build platform and a second feature on the conveyor, which may be brought into and out of contact with each other to effect engagement and disengagement. In examples, the first feature may be a driving dog and the second feature may be a following dog, or vice versa. In examples, the engagement mechanisms may be activated and deactivated to achieve engagement and disengagement magnetically, such as by controlling electromagnets of the engagement mechanisms.

In examples, the build platform is lockable relative to the build unit in the pre-print position and the post-print position. In such examples, the conveyor may be to be engaged with the build platform to move the build unit into and out of the print position and to move the build platform relative to the frame of the build unit, wherein the build platform is locked in the pre-print position while the build unit is moved into the print position, is locked in the post-print position while the build unit is moved out of the print position, and is not locked relative to the build unit during printing while the build unit is in the print position. In such examples, is in the engagement mechanism with the conveyor may be sufficient, wherein the part is moved by the conveyor is determined by the fact whether the build platform is locked to the frame or not. When the build platform is locked to the frame, the build platform is moved along with the frame. If the build platform is not locked to the frame and the frame is latched at the print position, the build platform is moved while the frame is not moved.

In examples, the build unit is locked in the print position upon reaching the print position. In order to lock the build unit in the print position, a stop may be provided, which may be arranged in the pathway of the build unit through the 3D printer so that, when the build unit hits the stop, it is arranged in the print position. When printing is finished, the stop may be removed from the pathway so that the build unit may be removed from the print position. In examples, at the same time that the build unit is locked into the print position, a feature of the same engagement mechanism that is otherwise used to attach the build unit to the conveyor may be used to attach the build unit at the desired position in the column guide.

In examples, the 3D printer comprises a first sensor to detect that the build unit reaches the print position when the conveyor moves the build unit into the print position, and a second sensor to detect that the build platform has reached a post-print position relative to the frame of the build unit after printing. In examples, the first sensor and the second senor are optical sensors. In examples, the second sensor is to monitor a driving force of the conveyor or a driving signal of the conveyor and to determine that the build platform has reached the post-print position using the monitored driving force or driving signal.

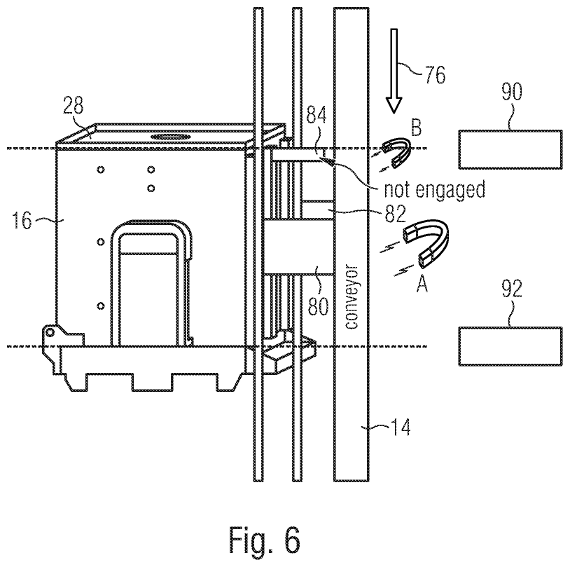

FIG. 6 shows schematically details of an example of a 3D printer comprising first and second sensors. To be more specific, a first barrier laser sensor 90 and a second barrier laser sensor 92 are provided. The barrier laser sensors may be to activate/deactivate the engagement mechanisms to either move the whole build unit or the build platform depending on the phase of the process. During movement of build unit 16 towards the print position, the first engagement mechanism 80, 82 is activated as indicated by a larger magnet in FIG. 6, and the second engagement mechanism 84 is deactivated as indicated by a smaller magnet in FIG. 6. In examples, the barrier laser sensors 90, 92 may be to detect a feature of build platform 28, such as a feature of the engagement mechanism coupled to build platform 28. When this feature crosses the first barrier laser sensor 90, build unit 16 is in the print position, first engagement mechanism 80, 82 is deactivated to disengage build unit 16 from conveyor 14, and second engagement mechanism 84 is activated to engage build platform 28 with conveyor 14. At this time, build unit 16 may be locked at the print position using an additional stop or through its constant attachment to the column guides. When this feature of the build platform crosses the second barrier laser sensor 92, printing is finished, first engagement mechanism 80, 82 is activated to engage build unit 16 with conveyor 14, and second engagement mechanism 84 is deactivated to disengage build platform 28 from conveyor 14.

In other examples, a single barrier laser sensor may be provided. In such examples, a lowest/bottom part of the build unit may cross the barrier laser sensor when the build unit reaches the print position. Then, the frame of the build unit is disengaged and the build platform is engaged with the conveyor. When the print job is finished, the build unit is still held in the print position and, therefore, the conveyor is not able to move the build platform further. Thus, the conveyor will try to increase the force/driving signal, which may be a pulse width modulated signal. The increase in the force/driving signal may be detected as an indication that the print job is finished. Thus, the fact that the print job is finished may be detected by monitoring conveyor telemetry. Once it is detected that the job is finished, the build platform is disengaged and the frame is engaged allowing the printed job to move downward.

In other examples, a single barrier laser sensor may be provided to detect the lowest/bottom part of the build unit as an indication that the build unit reached the print position and to detect a feature of the build platform as an indication that the print job is finished. The output of such a single barrier laser sensor may be used to control the first and second engagement mechanisms as explained above.

As explained above, a single conveyor may be used to effect movement of the whole build unit on the one hand and to effect movement of the build platform relative to the frame of the build unit on the other hand. In other examples, a separate conveyor may be used to move the build platform relative to the frame of the build unit. Even in such case, movement of the whole build unit on the one hand and movement of the build platform relative to the frame of the build unit are in the same direction so that quality issues due to a change in the moving direction may be avoided.

Examples of the disclosure provide a 3D printer comprising a printing machine to accommodate a build unit in a print position, the build unit comprising a frame and a build platform movable relative to the frame, wherein the printing machine is to print 3D objects on the build platform while the build platform moves relative to the frame. A conveyor is to move the build unit into the print position and out of the print position in a first direction, and to move the build platform relative to the frame in the first direction while the build unit is in the print position. In such examples, the conveyor may be to be engaged with the frame of the build unit to move the build unit into and out of the print position, to be disengaged from the frame of the build unit while the build unit is in the print position, and to be engaged with the build platform to move the build platform relative to the frame during printing while the build unit is in the print position. In such examples, the 3D printer may comprise a first sensor to detect that the build unit reaches the print position, and a second sensor to detect that the build platform has reached a post-print position relative to the frame of the build unit after printing.

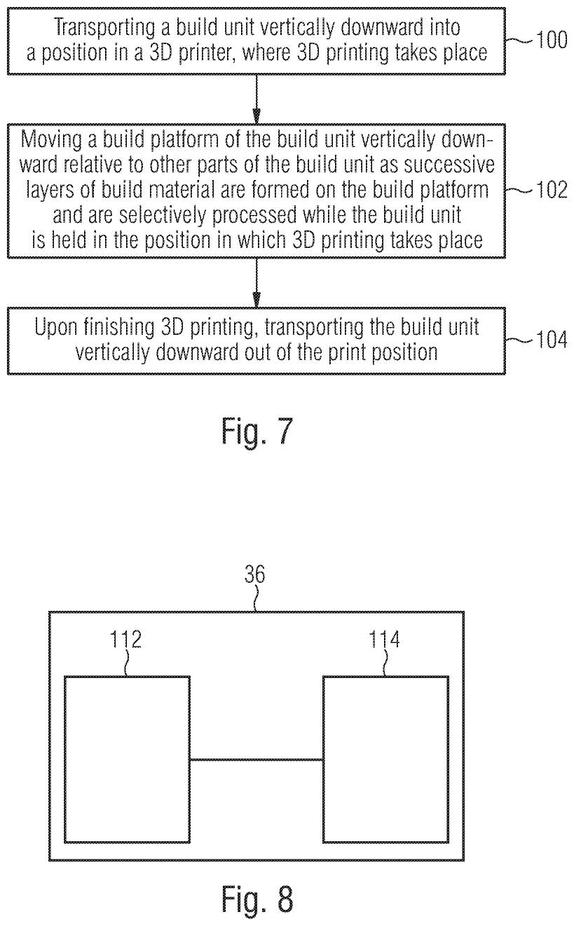

Examples of the present disclosure provide a method of 3D printing as shown in FIG. 7. At 100, a build unit is transported or moved vertically downward into a position in a 3D printer where 3D printing takes place. At 102, a build platform of the build unit is moved vertically downward relative to other parts of the build unit as successive layers of build material are formed on the build platform and are selectively processed while the build unit is held in the position in which 3D printing takes place. At 104, the build unit is moved vertically downward out of the print position when the build platform reaches a post-print position relative to the frame of the build unit upon finishing a print job.

FIG. 8 shows an example of controller 36. Controller 36 may be to provide the functionality described herein and to execute methods described herein. Controller 36 may be implemented, for example, by one or more discrete modules (or data processing components) that are not limited to any particular hardware and machine-readable instructions configuration. Controller 36 may be implemented in any computing or data processing environment, including in digital electronic circuitry, e.g., an application-specific integrated circuit, such as a digital signal processor (DSP) or in computer hardware, device driver, or machine-readable instructions. In some implementations, the functionalities are combined into a single data processing component. In other implementations, the respective functionalities may be performed by a respective set of multiple data processing components.

As shown in FIG. 8, controller 36 may comprise a processor 112 and a memory device 114 accessible by processor 114. Memory device 114 may store process instructions (machine-readable instructions, such as computer software) for implementing methods executed by controller 36. Memory device 114 may store instructions to control components of the printing apparatus to perform the purging processes described herein. Memory device 114 may include one or more tangible machine-readable storage media. Memory devices suitable for embodying these instructions and data include all forms of computer-readable memory, including, for example, semiconductor memory devices, such as EPROM, EEPROM, and flash memory devices, magnetic disks such as internal hard disks and removable hard disks, magneto-optical disks, and ROM/RAM devices. Routines and processes applied to print components 34 and conveyor 14 to perform the methods described herein may be stored in memory device 114.

Examples described herein may be realized in the form of hardware, machine-readable instructions or a combination of hardware and machine-readable instructions. Any such machine-readable instructions may be stored in the form of volatile or non-volatile storage such as, for example, a storage device, such as a ROM, whether erasable or rewritable or not, or in the form of memory such as, for example, RAM, memory chips, device or integrated circuits or an optically or a magnetically readable medium, such as, for example, a CD, DVD, magnetic disk or a magnetic tape. The storage devices and storage media are examples of machine-readable storage, that are suitable for storing a program or programs that, when executed, implement examples described herein.

In the foregoing Detailed Description, it may be seen that various features are grouped together in examples for the purpose of streamlining the disclosure. This method of disclosure is not to be interpreted as reflecting an intention that the claimed examples require more features than are expressly recited in each claim. Rather, as the following claims reflect, inventive subject matter may lie in less than all features of a single disclosed example. Thus, the following claims are hereby incorporated into the Detailed Description, where each claim may stand on its own as a separate example. While each claim may stand on its own as a separate example, it is to be noted that, although a dependent claim may refer in the claims to a specific combination with another claim or other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus.

All the features disclosed in the specification, including any accompanying claims, abstract and drawings, and/or all the features of any method or progress described may be combined in any combination, including and claim combination, except combinations where at least some of such features are mutually exclusive. In addition, features disclosed in connection with a system may, at the same time, present features of a corresponding method, and vice versa.

Each feature disclosed in the specification, including any accompanying claims, abstract and drawings, may be replaced by other features servicing the same, equivalent or a similar purpose, unless expressly stated otherwise. Thus, unless expressly stated otherwise, each feature disclosed is one example of a generic series of equivalent or similar features.

The foregoing has described the principles, examples and modes of operation. However, the teaching herein is not to be construed as being limited to the particular examples described. The above described examples are to be regarded as illustrative rather than restrictive, and it is appreciated that variations may be made in those examples by those skilled in the art without departing from the scope of the following claims.

1. A 3D printer comprising:
a printing machine to accommodate a build unit in a print position;
a conveyor to move the build unit into the print position and out of the print position,
wherein the conveyor is to move the build unit vertically downward into the print position and to move the build unit vertically downward out of the print position, and
wherein the 3D printer is to move a build platform of the built unit vertically downward relative to the a frame of the build unit as successive layers of build material are formed on the build platform and are selectively processed while the build unit is in the print position.

2. The 3D printer of claim 1, wherein the conveyor is to move the build platform vertically downward relative to the frame while the build unit is secured in the print position.

3. The 3D printer of claim 1, wherein the conveyor is to be engaged with the frame of the build unit to move the build unit into and out of the print position in the vertical direction and is to be engaged with the build platform to move the build platform relative to the frame in the vertical direction during printing while the build unit is in the print position.

4. The 3D printer of claim 2, comprising:
a first engagement mechanism to effect engagement between the frame of the build unit and the conveyor to move the build unit into and out of the print position and to effect disengagement of the frame of the build unit from the conveyor during printing while the build unit is in the print position; and
a second engagement mechanism to effect engagement between the build platform and the conveyor during printing while the build unit is in the print position and to effect disengagement of the build platform from the conveyor when the build unit is moved into and out of the print position.

5. The 3D printer of claim 1, wherein the build platform is lockable relative to the build unit in an pre-print position and a post-print position, wherein the conveyor is to be engaged with the build platform to move the build unit into and out of the print position and to move the build platform relative to the frame of the build unit, wherein the build platform is locked in the pre-print position while the build unit is moved into the print position, is locked in the post-print position while the build unit is moved out of the print position, and is not locked relative to the build unit during printing while the build unit is in the print position.

6. The 3D printer of claim 1, comprising a first sensor to detect that the build unit reaches the print position when the conveyor moves the build unit into the print position, and a second sensor to detect that the build platform has reached a post-print position relative to the frame of the build unit after printing.

7. The 3D printer of claim 6, wherein the first sensor and the second senor are optical sensors.

8. The 3D printer of claim 7, wherein the second sensor is to monitor a driving force of the conveyor or a driving signal of the conveyor and to determine that the build platform has reached the post-print position using the monitored driving force or driving signal.

9. The 3D printer of claim 6, wherein the 3D printer is to latch the build unit in the print position when the first sensor detects that the build unit reached the print position and to unlatch the build unit when the second sensor detects that the build platform has reached the post-build platform relative to the frame.

10. The 3D printer of claim 1, wherein the conveyor is to move the build platform of a first build unit relative to the frame of the first build unit when the first build unit is in the print position and to concurrently move a second build unit in the vertical direction towards the print position.

11. The 3D printer of claim 1, comprising a plurality of build units, wherein the conveyor is to move the build units of the plurality of build units into and out of the print position one after the other.

12. A 3D printer comprising:
a printing machine to accommodate a build unit in a print position, the build unit comprising a frame and a build platform movable relative to the frame, wherein the printing machine is to print 3D objects on the build platform while the build platform moves relative to the frame;
a conveyor to move the build unit into the print position and out of the print position in a first direction, and to move the build platform relative to the frame in the first direction while the build unit is in the print position.

13. The 3D printer of claim 12, wherein the conveyor is to be engaged with the frame of the build unit to move the build unit into and out of the print position, to be disengaged from the frame of the build unit while the build unit is in the print position, and to be engaged with the build platform to move the build platform relative to the frame during printing while the build unit is in the print position.

14. The 3D printer of claim 12, comprising a first sensor to detect that the build unit reaches the print position when the conveyor moves the build unit into the print position, and a second sensor to detect that the build platform has reached a post-print position relative to the frame of the build unit after printing.

15. A method of 3D printing, comprising:
transporting a build unit vertically downward into a position in a 3D printer, where 3D printing takes place;
moving a build platform of the build unit vertically downward relative to other parts of the build unit as successive layers of build material are formed on the build platform and are selectively processed while the build unit is held in the position in which 3D printing takes place; and
upon finishing 3D printing, transporting the build unit vertically downward out of the print position.
